(19) United States
(12) Patent Application Publication
(10) Pub. No.: US 2025/0333186 A1
(43) Pub. Date: Oct. 30, 2025

(54) METHOD AND DEVICE FOR DETECTING A DISCONNECTION STATE OF A PIPE FORMING PART OF A PUMPING SYSTEM OF A FUEL COLLECTOR OF AN AIRCRAFT

(71) Applicant: Airbus Operations (S.A.S.), Toulouse (FR)

(72) Inventor: Franck Dessertenne, Toulouse (FR)

(21) Appl. No.: 19/191,212

(22) Filed: Apr. 28, 2025

(30) Foreign Application Priority Data
Apr. 30, 2024 (FR) FR2404525

(51) Int. Cl. B64D 45/00; B64D 37/00

(52) U.S. Cl. CPC B64D 45/00; B64D 37/005

(57) ABSTRACT

A method includes a receiving step for receiving a value of the quantity of fuel present in the collector, a processing step including a sub-step for classifying the value received in the receiving step as a normal value, or as an abnormal value, a sub-step for computing the value of a health indicator, based on the received value, as well as on a predetermined number of values received beforehand, and a sub-step for comparing the value of the health indicator with a threshold to be able to detect a disconnection state, as well as a warning step for transmitting a warning in the event of the detection of a disconnection state, the method allowing, by taking into account the quantity of fuel present in the collector, reliable detection of a disconnection state and allowing operators, notably maintenance operators, to be warned.

### TECHNICAL FIELD

The disclosure herein relates to a method and a device for detecting a disconnection state of a pipe forming part of a pumping system of a fuel collector of an aircraft.

### BACKGROUND

It is known that an aircraft, in particular a transport airplane, includes a supply system for supplying the engines of the aircraft with fuel.

This fuel supply system generally comprises collectors that receive the fuel from fuel tanks, notably tanks installed in the wings of a transport airplane, and pumps for transferring the fuel from the collectors to the engines.

Each collector cell is also provided with an injection pump for maintaining the fuel filling level in the collector. To this end, a discharge pipe is connected to the outlet of the injection pump.

The discharge pipe may become mechanically separated from the injection pump and thus move, notably due to wear or a problem with the seal between the discharge pipe and the injection pump. Although such a disconnection does not prevent the fuel system from operating, because the collector still contains fuel, notably due to its position, and because the aircraft has several collectors, it can cause damage to the collector, mainly due to the pipe moving during flight.

Consequently, although it does not have an immediate impact, such a disconnection can result in medium- or long-term wear of the collector, which can generate significant repair costs and require the aircraft to be grounded.

Therefore, a requirement exists for a reliable solution to be provided for warning operators, notably maintenance operators, of such a disconnection state.

### SUMMARY

The aim of the disclosure herein is a solution for addressing the aforementioned requirement. It relates to a method for detecting a disconnection state of a pipe forming part of a pumping system of a fuel collector of an aircraft. According to the disclosure herein, the method comprises the following sequence of successive steps, which is implemented iteratively:
a receiving step, implemented by a receiver, for receiving a value of the quantity of fuel present in the collector;
a processing step, implemented by a processor of a computer, the processing step comprising:
a classification sub-step for classifying the value received in the receiving step, where applicable, as a value, called normal value, or as a value, called abnormal value;
a computation sub-step for computing the value of a health indicator, based on the normal or abnormal received value, as well as on a predetermined number of values received in previous iterations forming a sliding window; and
a comparison sub-step for comparing the value of the health indicator, computed in the computation sub-step, with a threshold so as to be able to detect a disconnection state; and
a warning step, implemented by a transmitter, for transmitting a warning at least in the event of the detection of a disconnection state.

Thus, by virtue of the disclosure herein, by taking into account the quantity of fuel available in the collector, it is possible to reliably detect a disconnection state of a pipe of a pumping system of a fuel collector of an aircraft and to transmit a corresponding warning. This allows maintenance personnel or other persons attending to the aircraft to be warned and notified as soon as such a disconnection appears and is detected, and thus allows the appropriate measures to be taken.

In a preferred embodiment, in the computation sub-step, the value of the health indicator:
is equal to zero, if the received value is normal;
is computed using the following expression, if the received value is abnormal:

$$HI = 100 ( N 1 / ( N 1 + N 2 ) ) ,$$

in which:
   N1 is the number of abnormal values in the sliding window; and
   N2 is the number of normal values in the sliding window.

Advantageously, in the classification sub-step, a measured value is considered:
to be an abnormal value if it is less than or equal to a first predetermined threshold value; and
to be a normal value if it is greater than the first predetermined threshold value and less than or equal to a second predetermined threshold value, with the second predetermined threshold value being greater than the first predetermined threshold value.

Furthermore, advantageously, if, in the classification sub-step, the received value is greater than the second predetermined threshold value, the computation sub-step, the comparison sub-step and the warning step are not implemented for this received value.

Furthermore, advantageously, the sequence of successive steps is implemented after each flight of the aircraft.

In a particular embodiment, the method comprises a warning inhibition operation allowing the warning step to be inhibited for a given duration, so that no warning is transmitted in the warning step during this given duration.

Furthermore, advantageously, in the warning step, the value of the health indicator computed in the computation sub-step is displayed on a screen.

Furthermore, advantageously, the method also comprises a preliminary step of measuring the value of the quantity of fuel in the collector, with this measured value being able to be used as the value to be taken into account in the receiving step.

The disclosure herein also relates to a device for detecting a disconnection state of a pipe forming part of a pumping system of a fuel collector of an aircraft.

According to the disclosure herein, the device comprises at least:
a receiver configured to receive a value of the quantity of fuel present in the collector;
a processor of a computer configured to:
classify the value received from the receiver, where applicable, as a value, called normal value, or as a value, called abnormal value;
compute the value of a health indicator based on the normal or abnormal received value, as well as on a predetermined number of previously received values, forming a sliding window; and
compare the value of the health indicator thus computed with a threshold so as to be able to detect a disconnection state; and
a transmitter configured to transmit a warning at least in the event of the detection of a disconnection state.

### BRIEF DESCRIPTION OF THE DRAWINGS

The appended figures will clearly show how the disclosure herein can be produced. Throughout these figures, identical reference signs denote similar elements.

FIG. 1 is a synoptic diagram of a device for detecting a disconnection state of a pipe forming part of a pumping system of a fuel collector of an aircraft.

FIG. 2 is a partial perspective view of an aircraft wing, showing the position of a fuel collector.

FIG. 3 is a partial perspective view of a pumping system of a fuel collector.

FIG. 4 schematically illustrates a method for detecting a disconnection state.

FIG. 5 is a graph illustrating the measured and received values of the quantity of fuel present in the fuel collector, which values are used to compute the values of a health indicator.

FIG. 6 is a graph illustrating successive computed values of a health indicator.

### DETAILED DESCRIPTION

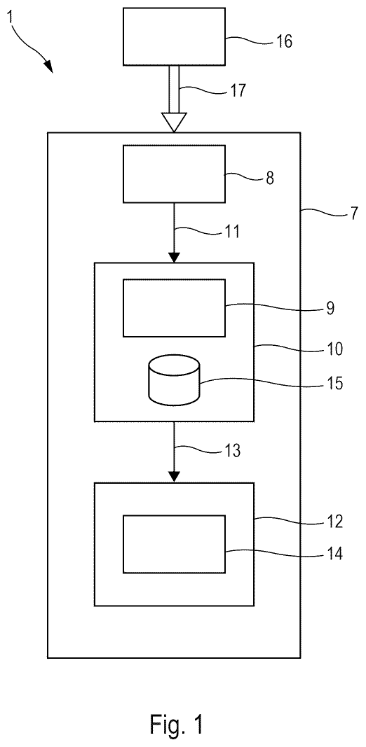

The device 1, which is used to illustrate the disclosure herein and is schematically depicted in a particular embodiment in FIG. 1, is intended to detect a disconnection state on an aircraft, in particular on a transport airplane.

More specifically, the device 1 is intended to detect a disconnection of a pipe 2 (or hose) of a pumping system 3 (FIG. 3) forming part of a fuel supply system of the aircraft. The (fuel) supply system, which is intended to supply the aircraft engines with fuel, conventionally includes collectors 4 that receive the fuel from fuel tanks, before it is transferred to the aircraft engines by the pumping system 3.

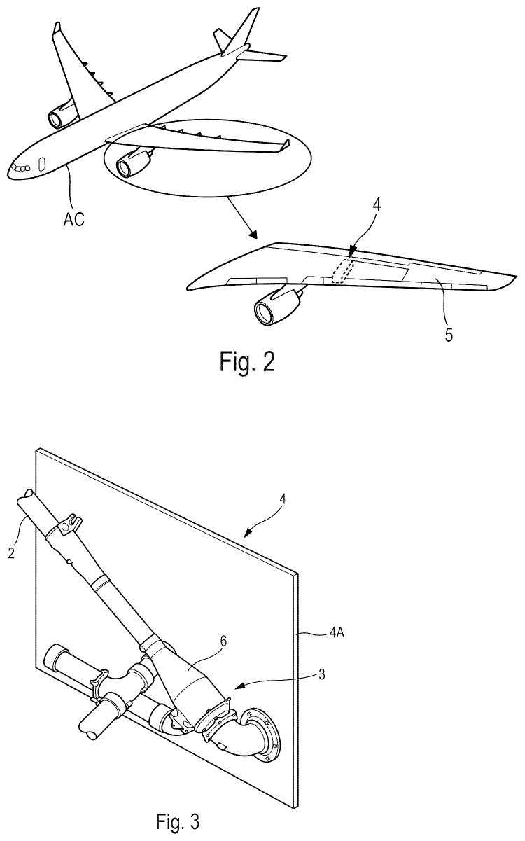

As schematically shown in FIG. 2, in a particular embodiment, a collector 4 to which the device 1 can be applied is arranged in a wing 5 of the aircraft AC. The pumping system 3 notably comprises an injection pump 6, which is associated with the collector 4, a wall 4A of which is schematically shown in FIG. 3, and which is intended to maintain a fuel filling level in the collector. The pipe 2 is attached to the outlet of the injection pump 6.

The aim of the device 1 is to detect a disconnection state corresponding to the disconnection of such a pipe 2 from the injection pump 6. Although it does not have an immediate impact, such a disconnection could result in medium- or long-term wear of the collector 4 that could generate significant repair costs and require the aircraft to be grounded.

Furthermore, in order to detect a disconnection state as described above, the device 1 comprises, as shown in FIG. 1, a set 7 of units, comprising at least:
a receiver 8 configured to receive a value of the quantity of fuel actually present in the collector 4;
a processor 9 of a computer 10 configured to:
classify the value received from the receiver 8 (via a link 11) mainly as a value, called normal value, or as a value, called abnormal value;
compute the value of a health indicator HI based on the normal or abnormal received (and classified) value, as well as on a predetermined number of previously received values and forming a sliding window, as specified hereafter; and
compare the value of the health indicator HI thus computed with a threshold so as to be able to detect a disconnection state; and
a transmitter 12 configured to transmit a warning at least when it is notified by the processor 9 (via a link 13) of the detection of a disconnection state.

The transmitter 12, for example, a display device, preferably comprises a screen 14 configured to display a visual message representing a warning, where applicable. The transmitter 12 can also display the value of the health indicator HI, computed by the processor 9, on the screen 14.

As a variant or in addition, the transmitter 12 can also transmit an audible warning.

The computer 10 also comprises a database 15 for storing the fuel quantity values (in the collector 4) successively received via the receiver 8.

The device 1 further comprises a measurement system 16 that is conventionally intended to measure the value of the quantity of fuel present in the collector 4, and to do so at successive instants. At least some of these measured values are received via the receiver 8.

The measurement system 16 is a standard system on board the aircraft that measures the quantity of fuel present in the collector 4, for example, using standard capacitance-type measuring probes or any other type of sensor, and notably does so during a flight of the aircraft. These measurements are stored in the measurement system 16 or in an appropriate memory of a system or a computer of the aircraft.

The device 1 (namely, the set 7) can be a device on board the aircraft or, preferably, a device installed on the ground, for example, in an airport.

In a preferred embodiment, the device 1 is installed in an airport regularly served by the aircraft and it is used, for example, by aircraft maintenance personnel. In this case, in a preferred embodiment, the receiver 8 is installed and configured to poll the measurement system 16 (or another aircraft system holding measurements taken by the measurement system 16) each time the aircraft arrives at an airport gate, so that it sends it, via a wireless data transmission link 17, the last measured value of the quantity of fuel present in the collector 4. This value that is received via the receiver 8 is then used by the device 1, as specified above.

In an alternative embodiment, the device 1 is installed on the aircraft, and the receiver 8 is configured to receive the values measured by the measurement system 16, via a standard link 17, for example, of the wired type, and this occurs either directly from the measurement system 16, or from another system of the aircraft holding the measurements taken by the measurement system 16.

The device 1, as described above, is able to implement a method P for detecting a disconnection state.

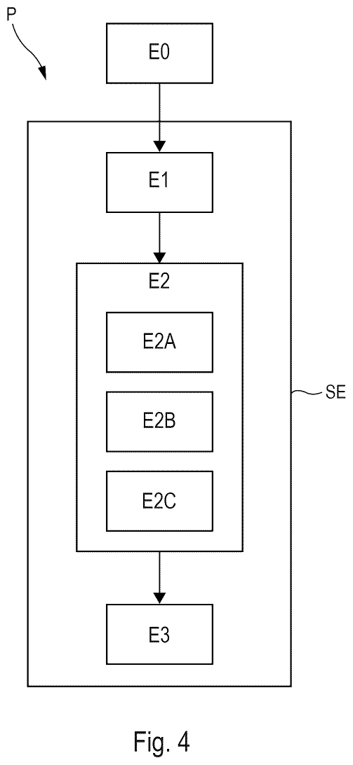

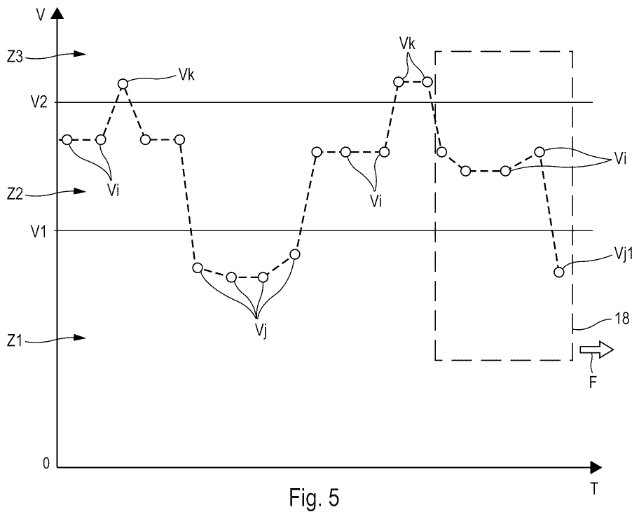

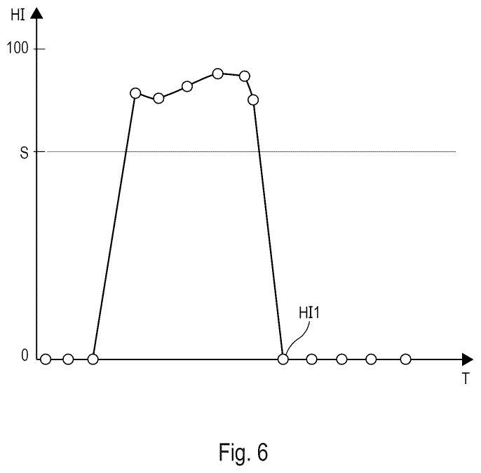

The method P comprises, as shown in FIG. 4, a sequence SE of successive steps, which is implemented iteratively. This sequence SE of successive steps comprises:
a receiving step E1, implemented by the receiver 8, for receiving a value indicating the quantity of fuel present in the collector 4;
a processing step E2, implemented by the processor 9 of the computer 10. This processing step E2 comprises:
a classification sub-step E2A for classifying the value received in the receiving step E1, where applicable, as a value, called normal value, or as a value, called abnormal value;
a computation sub-step E2B for computing the value of a health indicator HI, based on the normal or abnormal received value, as well as on a predetermined number of values received in previous iterations forming a sliding window 18 (FIG. 5); and
a comparison sub-step E2C for comparing the value of the health indicator HI (computed in the computation sub-step E2B), with a threshold S (FIG. 6) so as to be able to detect a disconnection state; and
a warning step E3, implemented by the transmitter 12, for transmitting a warning at least in the event of the detection of a disconnection state (abnormal).

The aforementioned steps E1, E2 and E3 will now be described in further detail.

In a particular embodiment, the receiving step E1 is implemented after each flight of the aircraft, notably when the device 1 is on board the aircraft, as indicated above.

Furthermore, in a preferred embodiment, the receiving step E1 is implemented each time the aircraft returns to the airport where the device 1 is installed. In this case, the receiver 8 polls the aircraft system containing the measured values in order to receive one or more measured values, for example, the value measured at the end of each flight. This receiving step E1 is preferably implemented each time the aircraft arrives at an airport gate.

Within the scope of the disclosure herein, the value V of the quantity of fuel present in the collector 4 can be a mass value (expressed in kg, for example) or a volume value (expressed in m³, for example). The measurement system 16 generally measures a volume value, which can then:
be used as such, as a volume value; or
be conventionally converted into a mass value.

Furthermore, the method P also comprises a preliminary step E0, in which the measurement system 16 measures the value V of the quantity of fuel in the collector 4. The measured values are stored in the measurement system 16 or in an appropriate memory of a system or a computer of the aircraft, where they are received by the receiver 8.

FIG. 5 illustrates a set of successive measured values V (received via the receiver 8) of the quantity of fuel, as a function of time T.

FIG. 5 shows three zones of values V:
a zone Z1 comprising the values Vj that are less than or equal to a predetermined threshold value V1;
a zone Z2 comprising the values Vi that are greater than the threshold value V1 and less than or equal to a threshold value V2, with the threshold value V2 being greater than the threshold value V1; and
a zone Z3 comprising the values Vk that are greater than the threshold value V2.

Simply by way of a non-limiting illustration, for a collector 4 with a maximum quantity of fuel of 1,600 kg:
the threshold value V1 can correspond, for example, to 900 kg; and
the threshold value V2 can correspond, for example, to 1,400 kg.

The aim of the classification sub-step E2A is to compare each received value with the threshold values V1 and V2 so that it can be positioned in one of the zones Z1, Z2 and Z3.

More specifically, in the classification sub-step E2A, a received value:
is considered to be an abnormal value if it is positioned in zone Z1, i.e., if it is less than or equal to the threshold value V1;
is considered to be a normal value if it is positioned in zone Z2, i.e., if it is greater than the threshold value V1 and less than or equal to the threshold value V2; and
is ignored, as specified hereafter, if it is positioned in zone Z3, i.e., if it is greater than the threshold value V2.

In this latter case, if the considered value is greater than the threshold value V2, the computation sub-step E2B, the comparison sub-step E2C and the warning step E3 are not implemented for this value. Therefore, no health indicator is computed and therefore no warning is transmitted. This state corresponds to a state in which an auxiliary power unit (APU) of the aircraft is operating such that the collector 4 is almost completely full.

Then, in the computation sub-step E2A that follows the classification sub-step E21, the processor 8 computes the value of the health indicator HI based on the last received value and based on whether it is considered to be normal or abnormal.

More specifically, the computation is carried out by the processor 8 as follows:
if the received value is normal, the value of the health indicator HI is equal to zero; and
if the received value is abnormal, the value of the health indicator HI is computed using the following expression:

$$HI = 100 ( N 1 / ( N 1 + N 2 ) ) ,$$

in which:
N1 is the number of abnormal values in the sliding window 18 (FIG. 5); and
N2 is the number of normal values in the sliding window 18.

The sliding window 18 comprises a predetermined number of values, namely, N1+N2 values, i.e., the last considered value (for example, the value Vj1 for the example in FIG. 5), as well as the (N1+N2-1) values (normal and/or abnormal) directly preceding this last value. The predetermined number of values can be selected according to the aircraft or the power supply system to which the method P is applied. Simply by way of a non-limiting illustration, it can be equal to 60. A minimum number of values also can be defined for the sliding window 18, for example, 5, from which the health indicator can be computed in the computation sub-step E2B, even if the predetermined number is not reached. An example of a sliding window 18 with an arrow F indicating its direction of movement is shown in FIG. 5.

Then, in the comparison sub-step E2C, the processor 8 compares the value of the health indicator HI (computed in the computation sub-step E2B) with a threshold S so as to be able to detect a disconnection state.

More specifically, if the value of the health indicator HI is less than or equal to the threshold S (FIG. 6), the state is considered to be normal, i.e., without any disconnection of the pipe 2 (FIG. 3).

However, if the value of the health indicator HI is greater than the threshold S, the state is considered to be a disconnection state (abnormal) corresponding to the disconnection of the pipe 2 from the injection pump 6 (FIG. 3).

Within the scope of the disclosure herein, the value of the threshold S can be adapted to the contemplated application and notably to the aircraft or to the supply system to which the method P is applied. The value of the threshold S, used in the comparison sub-step E2C, preferably ranges between 50 and 70, and is equal to 60, for example.

FIG. 6 is a graph illustrating an example of successive computed values of a health indicator. In this example, the values of the health indicator HI are greater than the threshold S for several points. A successful maintenance operation (a reconnection of the pipe 2) has been carried out, as illustrated by the zero values of the health indicator HI (representing a normal state) based on the value HI1.

Depending on the result of the comparison sub-step E2C (normal state or disconnection state), a warning may or may not be transmitted in the warning step E3.

If a disconnection state is detected, the transmitter 12 transmits a visual (and/or optionally audible) warning, in particular to warn maintenance personnel. This warning can be accompanied by the computed value of the health indicator HI being displayed.

If no disconnection state is detected, the transmitter 12 does not transmit any warning. In a particular embodiment, it can nevertheless notify the operators of the actual state.

The method P also comprises a warning inhibition operation allowing an operator to inhibit the transmitter 12 for a given duration, for example, for a few days, in order to prevent a warning from being transmitted in the warning step E3 in the event of a disconnection state being detected.

Such inhibition prevents a warning from being transmitted each time a new received value is processed, pending repair, while the maintenance personnel have been warned about a disconnection state, but the repair has not yet been carried out.

The device 1 and the method P, as described above, thus allow, by taking into account the quantity V of fuel available in the collector 4, a disconnection state of the pipe 2 to be detected in a completely reliable manner and allow a corresponding warning to be transmitted.

This allows maintenance personnel or other persons attending to the aircraft to be warned and notified as soon as such a disconnection appears and is detected. They can thus take the appropriate measures to prevent any damage to the collector, as well as in the vicinity of a rib or a stringer of the wing structure in the vicinity of the collector, from occurring or worsening.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for detecting a disconnection state of a pipe forming part of a pumping system of a fuel collector of an aircraft, the method comprising successive steps of:
a receiving step, implemented by a receiver, for receiving a value of the quantity of fuel present in the collector;
a processing step, implemented by a processor of a computer, the processing step comprising:
a classification sub-step for classifying the value received in the receiving step, where applicable, as a normal value, or as an abnormal value;
a computation sub-step for computing a value of a health indicator, based on the normal or abnormal received value, as well as on a predetermined number of values received in previous iterations forming a sliding window; and
a comparison sub-step for comparing the value of the health indicator, computed in the computation sub-step, with a threshold to be able to detect a disconnection state; and
a warning step, implemented by a transmitter, for transmitting a warning at least in an event of detection of a disconnection state.

2. The method according to claim 1,
wherein, in the computation sub-step, the value of the health indicator:
is equal to zero, if the received value is normal;
is computed using a following expression, if the received value is abnormal:
HI=100(N1/(N1+N2)),
in which:
N1 is a number of abnormal values in the sliding window; and
N2 is a number of normal values in the sliding window.

3. The method according to claim 1,
wherein, in the classification sub-step, a received value is considered:
to be an abnormal value if it is less than or equal to a first predetermined threshold value; and
to be a normal value if it is greater than the first predetermined threshold value and less than or equal to a second predetermined threshold value, with the second predetermined threshold value being greater than the first predetermined threshold value.

4. The method according to claim 3, wherein if, in the classification sub-step, the received value is greater than the second predetermined threshold value, the computation sub-step, the comparison sub-step and the warning step are not implemented for this received value.

5. The method according to claim 1, wherein steps are implemented after each flight of the aircraft.

6. The method according to claim 1, wherein, in the warning step, the value of the health indicator computed in the computation sub-step is displayed on a screen.

7. The method according to claim 1, comprising a warning inhibition operation allowing the warning step to be inhibited for a given duration, so that no warning is transmitted in the warning step during the given duration.

8. The method according to claim 1, comprising a preliminary step of measuring the value of the quantity of fuel in the collector, with this measured value being able to be used as the value to be taken into account in the receiving step.

9. A device for detecting a disconnection state of a pipe of a pumping system forming part of a fuel collector of an aircraft, comprising at least:
a receiver configured to receive a value of a quantity of fuel present in the collector;
a processor of a computer configured to:
classify the received value as a normal value, or as an abnormal value;
compute a value of a health indicator based on the normal or abnormal received value, as well as on a predetermined number of previously received values, forming a sliding window; and
compare the value of the health indicator thus computed with a threshold to be able to detect a disconnection state; and
a transmitter configured to transmit a warning at least in an event of detection of a disconnection state.
